(19) United States
(12) Patent Application Publication
(10) Pub. No.: US 2014/0367435 A1
(43) Pub. Date: Dec. 18, 2014

(54) LARGE GAME CARRIER

(71) Applicant: Colin Ralph Carlisle, Frankford (CA)

(72) Inventor: Colin Ralph Carlisle, Frankford (CA)

(21) Appl. No.: 13/919,420

(22) Filed: Jun. 17, 2013

(51) Int. Cl. B60R 9/06; B60P 3/05; B62D 63/06

(52) U.S. Cl. CPC B60R 9/06; B62D 63/062; B60P 3/05
USPC 224/519; 280/400

(57) ABSTRACT

A large animal carrier that has a receiver that attaches to an ATV. The large animal carrier has a V-shaped portion of a main beam and the receiver that allows the user to place the head of the large game animal into, thus securing the animal head portion in front of the V shaped portion allowing it to be towed from the field as the head and antlers prevent the animal from becoming dislodged from the carrier.

### BACKGROUND OF THE INVENTION

Game carriers are not new to the art. There are many such examples of the apparati to transport game from the field. However, none of the prior art devices have the utility of the present invention. One such example of prior art devices is U.S. Pat. No. 5,645,292 entitled, “ATV Trailer” issued on Jul. 8, 1997 to McWilliams, which teaches a trailer that is transported by an ATV via a hitch. This carrier is designed to transport large animals from the field. The trailer is flipped on its side and the animal is rolled onto the trailer. Then the trailer is rolled over to an upright position. The inherent problem with this device is that it requires a great deal of energy to roll the trailer on to its side, load it, and then roll it back to the upright position. It has been discovered that the present invention is simpler, in that, the user merely places the head of the animal in the V-shaped support. This is the loading process of the present device. Again, the prior art device requires possibly two or more people to complete the required process to load the device making it inherently inferior.

Another example of a prior art device is U.S. Pat. No. 8,376,391 entitled, “Cargo Carrying Device” issued on Feb. 19, 2013 to Voves that teaches a portable device capable of transporting a load across the ground.

The device is a frame construction with side rails. The device transitions from a horizontal position to an angled position. The device also has a hitch to be used as a trailer. This prior art device also suffers from drawbacks. The primary drawback being the user must lift the entire weight of the animal in order to place it upon the top surface of the carrier. If the user is alone this task, if not impossible, is potentially dangerous in that the user will be injured in the lifting process. Large deer, elk and moose pose an even greater effort and would require multiple people to lift the animal into place.

U.S. Pat. No. 8,366,125 entitled, “Wild Game Cart”, issued on Feb. 5, 2013 to Loomans teaches a cart for transporting game such as large animal carcasses across rough and obstructed terrain. This prior art device also suffers from the same limitations as the other prior art devices. The device is not capable of transporting truly large game. Again, large game is defined as the larger breeds of game animals that would include, but not be limited to Whitetail deer, mule deer, elk, moose and bear.

It has been discovered that the present invention allows a single user the ability to place the head or front portion of the large game animal into the v shaped portion of the device and remove it from the field.

### THE INVENTION

The present invention is a large game carrier. The large game carrier comprises a single beam that has a first end and a second end. The first end is configured to attach to a trailer tongue receiver. The second end has attached thereto, a V-shaped animal support.

### BRIEF DESCRIPTION OF THE DRAWINGS

FIG. 1 shows the device mounted to a single main beam.

FIG. 2 shows the hitch receiver inserted into an ATV.

FIG. 3 shows another embodiment of the device as the device is mounted to an axle.

FIG. 4 shows another embodiment of the device equipped with ball hitch receiver.

FIG. 5 shows another embodiment of the device equipped with a pintle hitch.

FIG. 6 shows another embodiment of the device where the V shaped support is slightly tilted forward.

### DETAILED DESCRIPTION OF THE DRAWINGS

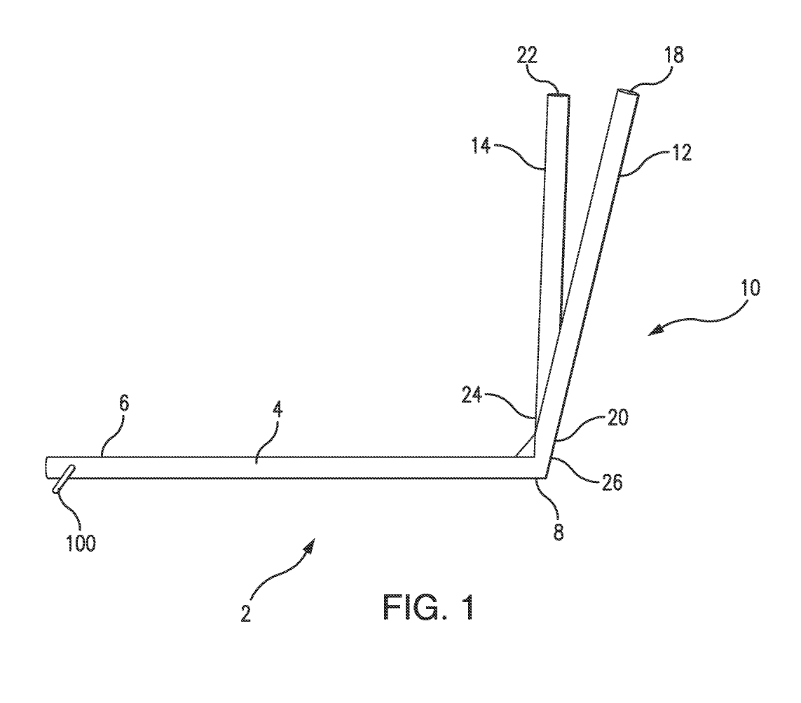

FIG. 1 shows the large animal carrier 2 featuring a single main beam 4. The single main beam 4 has a first end 6 a second end 8. The first end 6 is configured to be received within a receiver hitch 16 (net shown). The second end 8 of the single beam 4 has a V-shaped support 10 attached to it. The V-shaped support 10 has a first leg 12 and a second leg 14. The first leg 12 has a near end 18 and a distal end 20. The second leg 14 also has a near end 22 and a distal end 24. The distal ends 20 and 24 of the first leg 12 and the second leg 14 are joined together at their terminus 26 and attached to the single main beam 4 and its second end 8. The large animal carrier 2 is secured to the ATV that has a receiver hitch with a pin 100.

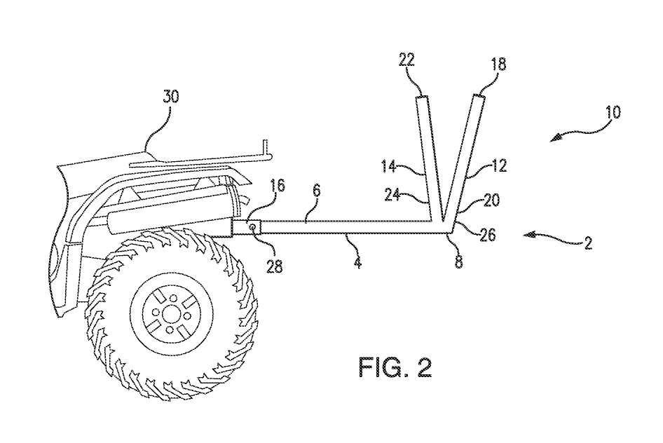

FIG. 2 shows the first end 6 of the single main beam 4 inserted into an ATV's 30 hitch receiver 16. The single main beam 4 has first end 6 and a second end 8. The second end 8 has a V-shaped support 10 attached to it. The V-shaped support 10 has a first leg 12 and a second leg 14. The first leg 12 has a near end 18 and a distal end 20. The second leg 14 has a near end 22 and a distal end 24. The distal ends 20 and 24 of the first leg 12 and the second leg 14 are joined together at the terminus 26 forming the V-shaped support 10. From this Figure it is clear that once the first end 6 is inserted into the receiver hitch 16 it is free standing from the ATV 30. The user can now place a large animal in the large animal carrier 2 and remove it from the field easily. The head and antlers of the large game animal become wedged into the V-shaped support 10. It is just as easy to remove the large animal from the large animal carrier 2. The user simply lifts the head out of the V-shaped support 10 and it is removed.

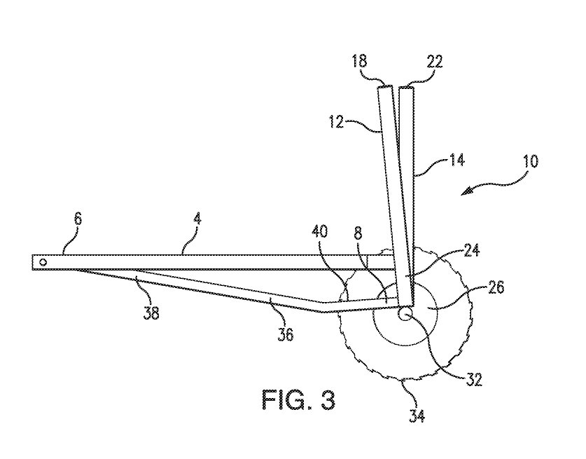

FIG. 3 shows another embodiment of the large animal carrier 2 as the large animal carrier 2 is mounted to an axle 32. The large animal carrier 2 is attached to an ATV and hauled into and out of the field. The single main beam 4 has a first end 6 and a second end 8. The second end 8 has a V-shaped support 10 attached to it. The V-shaped support 10 has a first leg 12 and a second leg 14. The first leg 12 has a near end 18 and a distal end 20. The second leg 14 has a near end 22 and a distal end 24. The distal ends 20 and 24 of the first leg 12 and the second leg 14 are joined together at the terminus 26 forming the V-shaped support 10. This embodiment has as second support beam 36 that supports the single main beam 4 and connects to the axle 32 which is supported by the tire 34. This embodiment allows the large animal carrier 2 to haul very large game animals from the field. Once again the carrier 2 allows one person to use the device where help is not available. The user just places the head of the animal past the V-shaped support 10 and it locks into the V-shaped support 10 by gravity as the weight is pushed downward the animal becomes wedged into the V-shaped support 10. It has also been discovered that the antlers of the game animal will catch on the first and second legs 12 and 14 making it impossible for the animal to become free from the device 2 during the removal operation.

The near tire 34 has been removed from the figure to allow a view of the axle 32. It has been discovered that the axle 32 in this embodiment allows for greater support for larger animals.

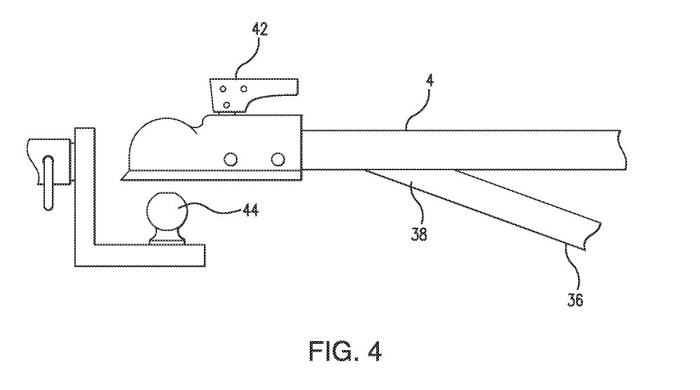

FIG. 4 shows another embodiment of the device 2 as a ball hitch receiver 42. The ATV 30 must be equipped with a ball hitch 44. The large game carrier 2 with the axle 32 is equipped with the ball hitch receiver 42 that will receive the ball hitch 44 to make the connection from the large game carrier 2 and the ATV 30 to haul the large game carrier 2 into and out of the field.

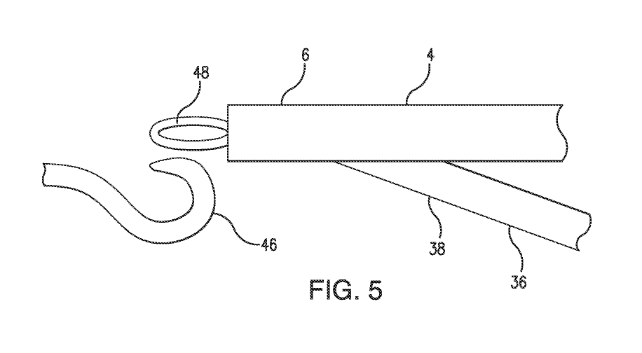

FIG. 5 shows another embodiment of the large game carrier 2 where the hitch of the device as a pintle hitch 50. The ATV 30 has to be equipped with a large hook 46. The large animal carrier 2 is equipped with a large opening 48. The hook 46 and the opening 48 are connected to attach the ATV 30 to the large animal carrier 2 to transport the large animal carrier 2 into and out of the field.

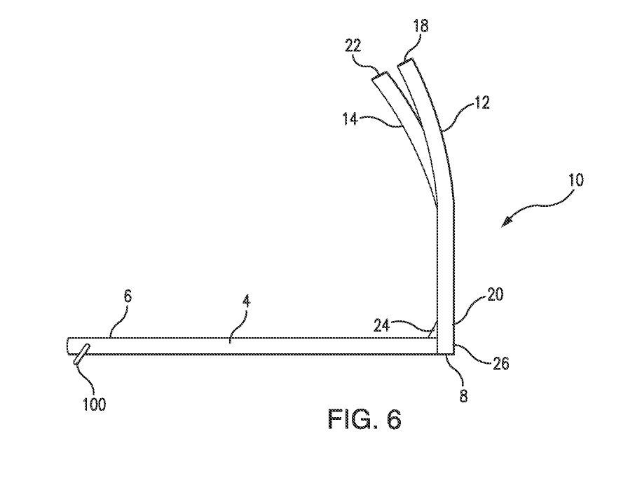

FIG. 6 shows another embodiment of the device 2 where the V shaped support 10 is slightly tilted forward. This figure shows the large animal carrier 2 featuring a single main beam 4. The single main beam 4 has a first end 6 a second end 8. The first end 6 is configured to be received within a receiver hitch 16 (not shown). The second end 8 of the single beam 4 has a V-shaped support 10 attached to it. The V-shaped support 10 has a first leg 12 and a second leg 14. The first leg 12 has a near end 18 and a distal end 20. The second leg 14 also has a near end 22 and a distal end 24. Both the first leg 12 and the second leg 14 are slightly tilted forward. This allows the user to have a greater hold on the animal in the device 2. The distal ends 20 and 24 of the first leg 12 and the second leg 14 are joined together at their terminus 26 and attached to the single main beam 4 and its second end 8. The large animal carrier 2 is secured to the ATV that has a receiver hitch with a pin 100.

The device 2 in the trailer embodiment or the axle mounted embodiment can be used by a single user even for the largest of game animals by unhitching the device 2 and standing it on end with the V shaped portion 10 making contact with the ground. The head of the animal is placed across the V shaped portion 10. Then the user must grasp the hitch end and using it as a lever lift the large animal into the carrier 2.

Another advantage of the large animal carrier 2 is the greater level of protection it provides in antler or rack protection. Many hunters will mount their trophies. These mounts are typically a head mount or a shoulder mount. The large animal carrier provides a greater utility in that once the animal is placed within the V shaped portion 10 the front shoulders and rack or antlers are further away from the ground during transportation therefore eliminating potential damage to either the antler or the front shoulder area.

The first embodiment uses a receiver type hitch. Another embodiment uses a ball hitch with a receiver. While yet another embodiment use a pintle and hook type hitch. It should be known that any type of hitch that will connect the device to a mode of transportation is acceptable and should be considered applicable to the spirit of this invention without deviation from the invention.

What is claimed is:

1. A large game carrier, said large game carrier comprising:
a single beam having a first end and a second end;
said first end configured to attach to a trailer tongue receiver;
said second end having attached thereto, a V-shaped animal support.

2. A large game carrier as claimed in claim 1, wherein said single beam and V-shaped support are mounted on an axle having two ends, said axle being supported by a set of wheels rotatably attached to each end of the said two ends of said axle.
